(19) United States
(12) Patent Application Publication
(10) Pub. No.: US 2025/0174971 A1
(43) Pub. Date: May 29, 2025

(54) REINFORCEMENT BRACKET FOR SUPPORT OF ELECTRICAL DEVICES

(71) Applicant: ERICO International Corporation, Solon, OH (US)

(72) Inventor: Michael Hung-Sun Oh, Twinsburg, OH (US)

(21) Appl. No.: 18/960,200

(22) Filed: Nov. 26, 2024

Related U.S. Application Data
(60) Provisional application No. 63/603,016, filed on Nov. 27, 2023.

(51) Int. Cl. H02G 3/12; F16M 13/02

(52) U.S. Cl. CPC H02G 3/121; F16M 13/02

(57) ABSTRACT

A bracket assembly can be utilized to support electrical devices relative to building structures. The bracket assembly may include a support bracket including a first bracket member slidably nested with a second bracket member to adjustably provide a range of extension lengths of the support bracket to support an electrical device between a first building structure and a second building structure. The bracket assembly may further include a reinforcement bracket secured to the first bracket member and the second bracket member. The reinforcement bracket may include a first reinforcement member telescopically movable relative to a second reinforcement member to provide a range of reinforcement lengths of the reinforcement bracket.

### CROSS-REFERENCE TO RELATED APPLICATIONS

This application claims priority to and incorporates by reference U.S. provisional patent application No. 63/603,016, filed Nov. 27, 2023.

### BACKGROUND

In some contexts, it may be useful to support electrical boxes, luminaires, or other objects relative to building structures.

### SUMMARY

Embodiments of the invention can provide improved brackets for supporting electrical boxes or other equipment between studs. Some embodiments provide a bracket assembly to support electrical devices relative to building structures. The bracket assembly may include a support bracket configured to support an electrical device between a first building structure and a second building structure. The support bracket may include a first bracket member securable to the first building structure and a second bracket member securable to the second building structure. The first bracket member may be slidably nested with the second bracket member to define an upper rail, and a lower rail. The upper and lower rails can be spaced apart from the upper rail to define a bracket opening that receives the electrical device, and provide telescopic adjustment of a length of the support bracket between the first and second building structures, via telescopic adjustment of the upper and lower rails. The bracket assembly may further include a reinforcement bracket secured to the first bracket member and the second bracket member along one of the upper rail or the lower rail. The reinforcement bracket can include a first reinforcement member slidably nested with a second reinforcement member to provide telescopic adjustment of a length of the telescoping reinforcement bracket along the one of the upper rail or the lower rail.

Some embodiments provide a bracket assembly to support electrical devices relative to building structures. The bracket assembly may include a support bracket including a first bracket member slidably nested with a second bracket member to adjustably provide a range of extension lengths of the support bracket to support an electrical device between a first building structure and a second building structure. The bracket assembly may further include a reinforcement bracket secured to the first bracket member and the second bracket member. The reinforcement bracket may include a first reinforcement member telescopically movable relative to a second reinforcement member to provide a range of reinforcement lengths of the reinforcement bracket.

Some embodiments provide a method of assembling a bracket assembly. The method may include slidably adjusting a first bracket member of a telescoping support bracket nested within a second bracket member relative to the second bracket member. The method may include slidably adjusting a first reinforcement member of a telescoping reinforcement bracket nested within a second reinforcement bracket member relative to the second reinforcement bracket member. The method may include securing the telescoping reinforcement bracket to the first bracket member and the second bracket member.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view a support assembly including a reinforcement bracket according to an embodiment of the invention;

FIG. 2 is a front elevation view of a support bracket of the support assembly of FIG. 1;

FIGS. 3A and 3B show front elevation views of first and second telescoping members of the bracket of FIG. 1;

FIG. 4 is a rear elevation view of the reinforcement bracket nested with the support bracket of the support assembly of FIG. 1;

FIG. 5 is an isometric view of the reinforcement bracket of the support assembly of FIG. 1;

FIG. 6A is a front elevation view of a first reinforcement member of the bracket assembly of FIG. 1;

FIG. 6B is a front elevation view of a second reinforcement member of the bracket assembly of FIG. 1;

FIG. 7A is a partial side elevation view of a cross-section of an upper rail of the support assembly of FIG. 1, taken at VII-VII of FIG. 1;

FIG. 7B is a partial side elevation view of a cross-section of a lower rail of the support assembly of FIG. 1, taken at VII-VII of FIG. 1;

FIG. 8A is a front axonometric partial view of an end of the first reinforcement member of FIG. 6A; and

FIG. 8B is a top axonometric partial view of a middle portion of the reinforcement bracket of the support assembly of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The discussion herein is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In some installations, building codes or other considerations may require that electrical boxes or other components be supported above a floor. As noted above, support brackets can be used to support electrical boxes or other components between building structures (e.g., between standard-size metal studs). For example, some support brackets can be telescopically adjustable to allow the brackets to be secured to studs that are different distances apart. When supporting electrical boxes between building structures that are spaced apart by a large distance (for example, more than 14 inches, or more than 17 inches), some conventional telescopically adjustable brackets can be prone to flex, bend, or otherwise perform adversely.

Embodiments of the disclosed invention may address these and other issues, including by providing a support assembly having a telescopically adjustable support bracket and separate, easily installable reinforcement rails that can mitigate potential flexing or other adverse response of the support brackets to loading. Providing reinforcement rails as described below can increase versatility of telescopically adjustable support brackets, allowing the support brackets to be secured to building support structures thar are spaced a greater distance from one another than may be possible with conventional brackets.

In some embodiments, a support assembly for supporting equipment between two building support structures can include a telescopically adjustable support bracket. The support bracket can include a first member slidably nested in a second member. The first and second members may each include one or more rails that can engage with one another to form one or more telescopic rails (e.g., each formed by a respective set of nested rails of the first and second members). During installation, the first member can be slidably adjusted relative to the second member and secured to two building support structures that can be spaced apart by a large range of distances.

In some embodiments, a reinforcement bracket can be secured to the support bracket to provide extra strength and stability to a corresponding support assembly, e.g., to prevent flexing and bending of the support bracket after installation. The reinforcement bracket can include a first reinforcement member that can be slidably nested with a second support member. The reinforcement bracket can be telescopically adjusted to a plurality of lengths by sliding the first member relative to the second member.

In some installations, a reinforcement bracket can be telescopically adjusted to a length that is similar to a length of a telescopic rail of a corresponding support bracket. In some embodiments, the reinforcement bracket can be nested with a telescopic rails (e.g., from a rear side of the telescopic rail, in a nesting direction that is transverse to a telescopic extension direction of the assembly). The nesting of the reinforcement bracket with the telescopic rail can provide extra points of contact to further secure the reinforcement bracket to the telescopic rail while greatly reducing flexing or bending of the reinforcement bracket. In some embodiments, a reinforcement bracket can be secured to each rail of a set of nested rails of a support bracket.

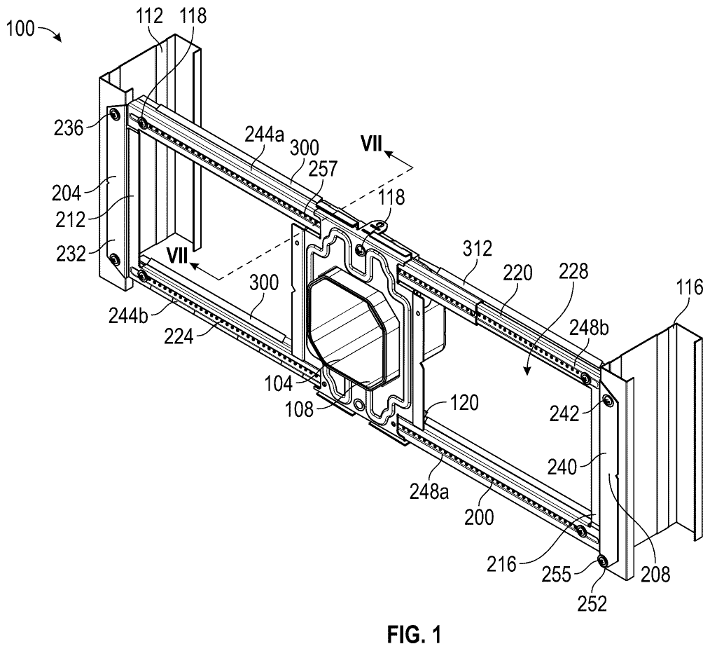

FIG. 1 illustrates an example support assembly 100 configured to support equipment 104 (e.g., an electrical box assembly 108 or other electrical assemblies) between a first and second building structure 112, 116 (e.g., studs). The support assembly 100 can include a support bracket 200 configured to support the equipment 104, above a floor of the building, between the first and second building structures 112, 116.

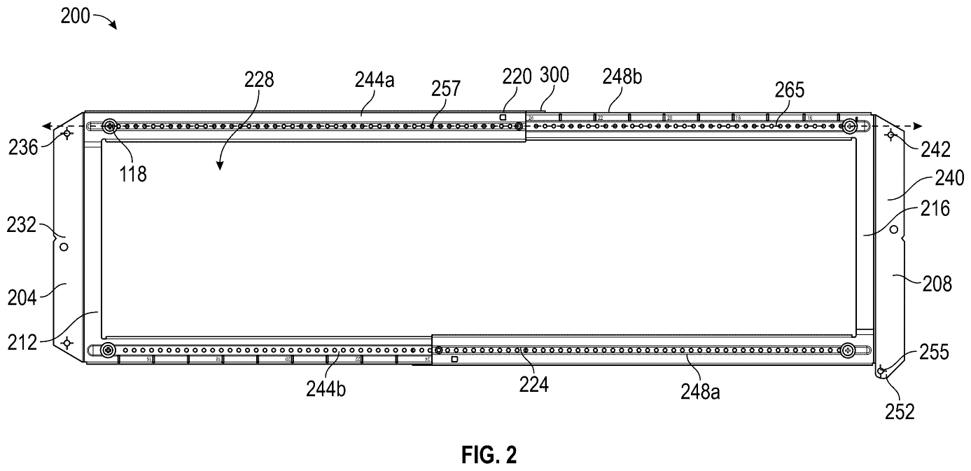

FIG. 2 illustrates an example configuration of a support bracket 200 of the support assembly 100, to support the equipment 104 between the first and second building structures 112, 116 (as shown in FIG. 1) or other building structures (e.g., other types of building studs than shown in FIG. 1). In the embodiment shown, the support bracket 200 is formed from a first telescoping member 204 and a second telescoping member 208, which include respectively a first side body 212 and a second side body 216. The side bodies 212, 216 are connected together by telescopic engagement along a first telescoping rail 220 and a second telescoping rail 224 (e.g., each formed by respective sets of rails of the members 204, 208, nested telescopically together).

In some cases, telescoping members can be substantially identical, which may, for example, reduce manufacturing steps necessary to produce dissimilar parts, generate material savings in the manufacturing process, and simplify packaging and transportation of telescoping members. In some cases, telescoping members can be substantially identical except for a limited number of features (e.g., a pivot tab, as discussed below). In some cases, a telescoping member can be formed as an integral component (e.g., as formed in a single piece using stamping operations on a metal blank).

Generally, electrical boxes, and other equipment may be installed in an interior area 228 defined by the perimeter of the side bodies 212, 216 and the sets of rails 220, 224. In some examples, a size of the interior area 228 can be adjusted to retain one or more pieces of the equipment 104 of various types, sizes and configurations. Specifically, in the example shown, the length of the interior area 228 can be adjusted by telescopically adjusting the rails 220, 224 to change a distance between the side bodies 212, 216.

As illustrated in FIG. 1, the electrical box assembly 108 is supported within the interior area 228 by a centerplate bracket secured to the rails 220, 224. Accordingly, the equipment 104 (e.g., the electrical box assembly 108) may be installed at any of a plurality of location between the side bodies 212, 216. In particular, the interior area 228 may define an interior area length extending from the side body 212 to the side body 216, and may further define an interior area width extending between the first and second rails 220, 224 (i.e., in a height direction in the illustrated installation). In some examples, including as shown, the interior area width may be consistent along an entirety of the interior area length, to allow the equipment to be positioned at various different locations along the interior area 228 and, thus, at various different locations between the first and second building structures 112, 116 during installation (as shown in FIG. 1). In other examples, other configurations are possible (e.g., with openings of different lengths between studs, or other characteristics).

In different arrangements, different features can be provided on a bracket to secure the bracket to building structures. For example, in the illustrated embodiment, the first side body 212 includes a first mounting flange 232 with one or more mounting openings 236, and the second side body 216 includes a second mounting flange 240 with one or more mounting openings 242. As illustrated in FIG. 1, when mounting the support bracket between the vertical building structures 112, 116, fasteners may fasten each of the four corners of the support bracket 200 to the building structures 112, 116. In other contexts, it may be advantageous to utilize only two fasteners (e.g., located near a centerline of the support bracket).

The mounting flanges 232, 240 can be shaped to prevent corners of the flanges from catching on a floor or on edges of studs during installation, and can further be shaped to provide case of manufacturing. For example, as shown in FIGS. 1 and 2, each of the mounting flanges 232, 240 can define a trapezoidal shape. As illustrated, a proximal side of each of the mounting flanges 232, 240 that is most proximate to the interior area 228 can be longer than a distal side of the corresponding mounting flange 232, 240 most distant from the interior area 228, and the distal side and the proximal side can be parallel.

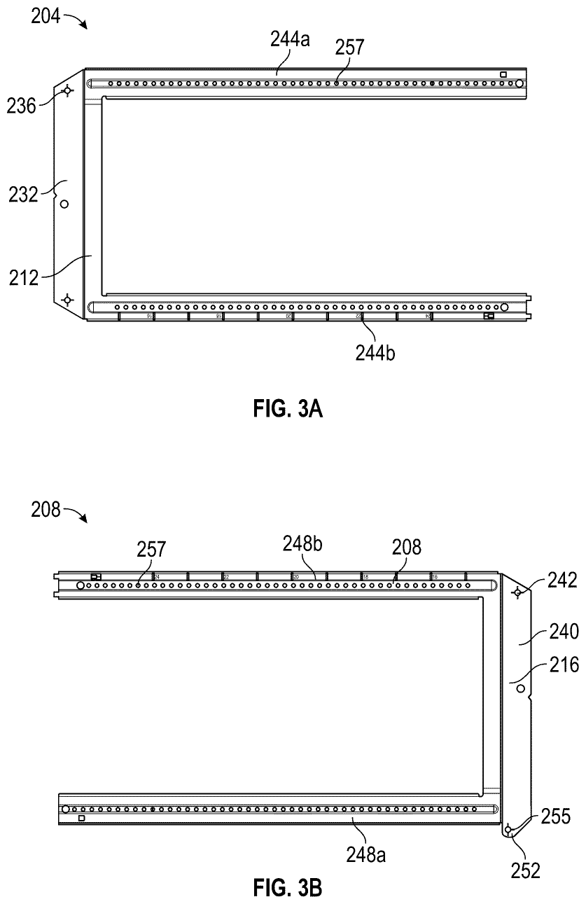

In different examples, different types of telescoping arrangements (e.g., rail profiles) can be used. In the illustrated example, as also noted above, the support bracket 200 includes the two telescoping members 204, 208. As shown in FIG. 3A, in particular, the first member 204 includes rails 244a, 244b, joined by the first side body 212. As shown in FIG. 3B, the second member 208 includes rails 248a, 248b, connected by the second side body 216. Further, the members 204, 208 can be substantially identical (e.g., formed as integrally stamped substantially identical bodies), other than a pivot tab 252 included on the second member 208. The pivot tab 252 can integrally extend outward in the elongate direction from the first mounting flange 232, away from the interior area 228, and includes a pivot tab opening 255 which may be used in fastening the support bracket 200 to the first and second building structures 112, 116 for installation (as shown in FIG. 1).

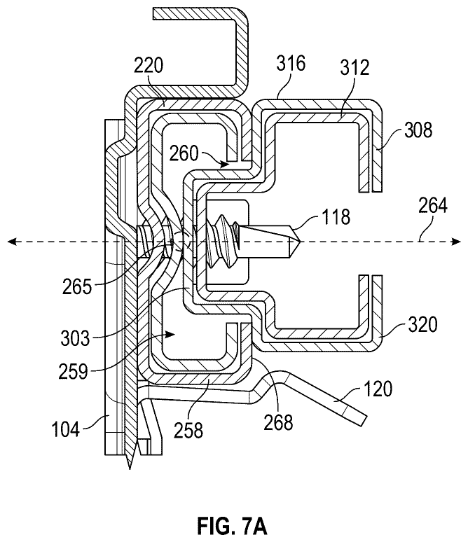

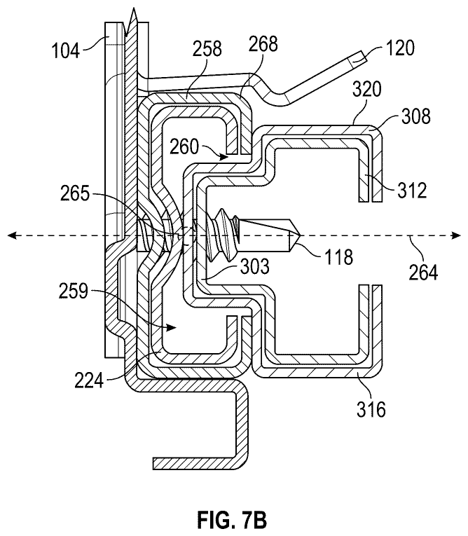

Generally, the rails 244a, 244b, 248a, 248b are sized to nestingly engage each other to form the telescoping rails 220, 224, to provide telescoping adjustability for the support bracket 200. As illustrated in FIGS. 7A and 7B, the rails 244a, 248a can accordingly have a larger cross-sectional profile than the rails 244b, 248b, so that the rail 244a can slidingly receive the rail 248b, and the rail 248a can slidingly receive the rail 244b. As illustrated in FIG. 2, the nesting of the rail 248b within the rail 244a can form the first rail 220, and the nesting of the rail 244b within the rail 248a can form the second rail 224, although other configurations of inner and outer nested components are possible.

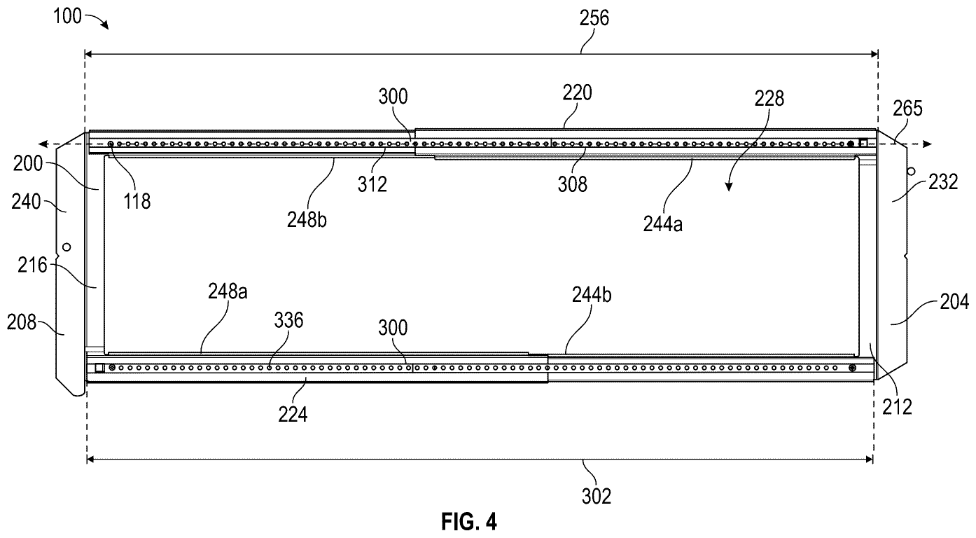

In particular, the illustrated arrangement allows the first member 204 to be slidably nested with the second member 208, providing the ability to telescopically adjust an extension length of the support bracket 200 along an extension direction to span a range of distances between the first support structure 112 and the second support structure 116 (see FIG. 1). Specifically, an extension length 256 of the rails 220, 224, measured between opposite ends of the rails 220, 224, may be telescopically adjusted to a range of different length to allow the mounting flanges 232, 240 to be secured to the support structures 112, 116 that are spaced apart by different distances (as shown in FIG. 4). While FIG. 2 shows a system with two sets of telescoping rails 220, 224, some embodiments could vary in this regard, for example by having fewer (or more) than two sets of telescoping rails.

In some examples, the bracket members 204, 208 include a plurality of support bracket mounting holes 257, configured to receive fasteners 118 for securing the equipment 104, and other components to the support bracket 200. For example, each of the rails 244a, 244b, 248a, 248b may include the plurality of support bracket mounting holes 257. The plurality of support bracket mounting holes 257 are spaced apart along each of the rails 244a, 244b, 248a, 248b. In some examples, the plurality of support bracket mounting holes 257 can be equidistantly spaced along each respective one of the rails 244a, 244b, 248a, 248b. For example, adjacent support bracket mounting holes 257 may be spaced apart by a first spacing along the rail 244a. Furthermore, adjacent support bracket mounting holes 257 may be spaced apart by similar spacing (e.g., the first spacing, as noted above) on related sets (e.g., each) of the rails 244b, 248a, 248b.

The support bracket mounting holes 257 of the rail 244a (or 244b) may be arrayed to be selectively oriented in different alignments with the support bracket mounting holes 257 of the rail 248b (or 248a), by adjustment of an extension length of the support bracket 200. Accordingly, aligned sets of the mounting holes 257 on overlapping portion of the rails 244a, 248b (or 244b, 248a) can cooperatively receive known types of fasteners 118 (e.g., screws, as shown in FIG. 1) to secure various components to the support bracket 200 the equipment 104 or a reinforcement bracket, as further discussed below). In other examples, the equipment 104 or a reinforcement bracket may instead be secured to the support bracket 200 via one or more of the fasteners 118 extending through the support bracket mounting holes 257 of either the first bracket member 204 or the second bracket member 208 (e.g., but not the other of the bracket member 208, 204, respectively).

As described above, support brackets that are secured between support structures and are separated by a large distance can tend to flex or otherwise fail when subjected to particular external forces. In some applications, for example, these effects can be particularly pronounced for distances that are more than 14 inches, or more than 17 inches. Accordingly, some conventional brackets can provide a relatively narrow application scope, limiting installers to installations of electrical boxes, or other equipment, only between support structures that are separated by 14 inches (or 17 inches) or less.

To address this issue in some cases, as illustrated in FIGS. 1 and 4, one or more reinforcement brackets 300 can be installed onto the support bracket 200, in order to reduce flex or failure of the support bracket 200 after installation. In some examples, as shown, the reinforcement bracket 300 may be installed onto a rear side of the support bracket 200. Installing the reinforcement bracket 300 on the rear side of the support bracket 200 can potentially reduce interference associated with the installation of the electrical box assembly 108 (or other equipment 104), on a front side of the support bracket 200, as well as avoid interference with other components (e.g., installed drywall) or operations (e.g., installation of drywall or electrical devices).

In some examples, the equipment 104, such as the electrical box assembly 108, can be secured to the front side of the support 200 via an equipment bracket (e.g., of various known types). For example, the equipment bracket can be secured to both the first rail 220 and the second rail 224 and may retain the electrical box assembly 108 relative to the rails 220, 224.

Generally, the reinforcement bracket 300 can be mounted to the rear side of the first rail 220 using a set of the fasteners 118 (e.g., a screw, rivet, bolt, or any other known fastener), although other configurations are possible. The reinforcement fasteners 118 can fasten either end of the reinforcement bracket 300 to either end of the first rail 220, or can be installed in other locations in some cases. In some embodiments, a second reinforcement bracket (e.g., a second instance of the bracket 300) can be mounted to a rear side of the second rail 224 (e.g., in a similar fashion as described above).

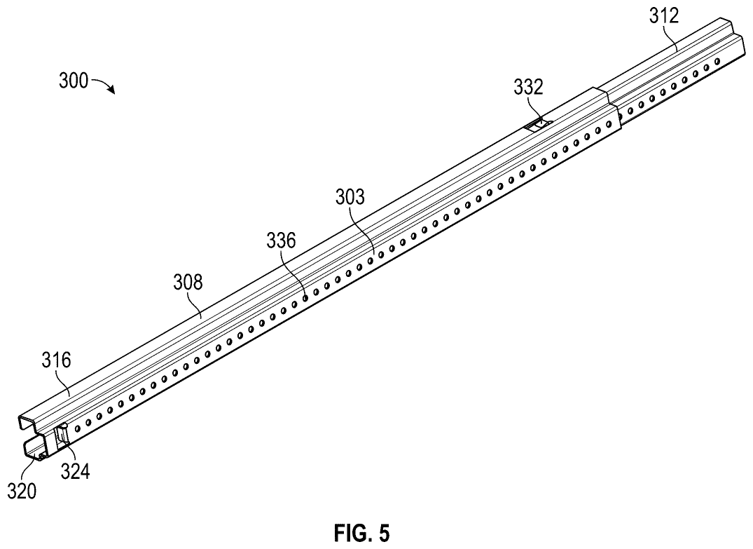

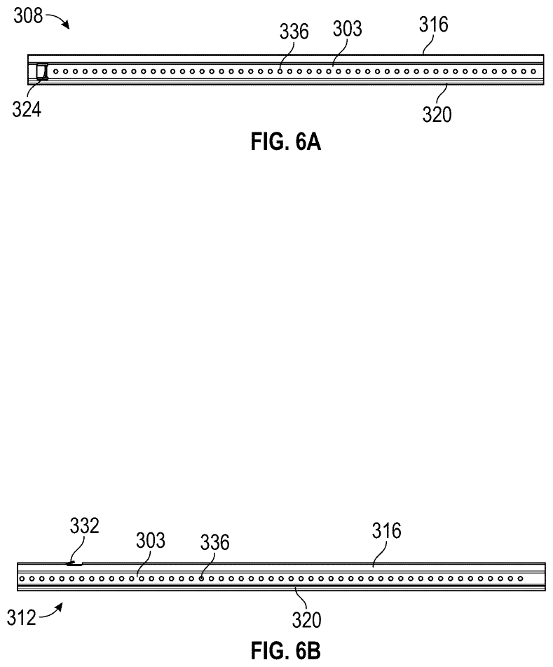

Prior to installation, a reinforcement extension length 302 (as shown in FIG. 4) of the reinforcement bracket 300 can be adjusted to fit the extension length 256 of the rails 220, 224 (e.g., to be somewhat smaller than the extension length 256, as detailed below). In some examples, the bracket 300 can be telescopically adjusted to a desired length. For example, referring to FIG. 5, the reinforcement bracket 300 may include a first reinforcement member 308, and a second reinforcement 312 slidably nested with the first reinforcement member 308. As illustrated in FIGS. 7A and 7B, the first reinforcement member 308 can have a larger cross-sectional profile than the second reinforcement member 312, so that the first reinforcement member 308 can slidingly receive the second reinforcement member 312. This arrangement, for example, allows the reinforcement bracket 300 to telescopically adjust the reinforcement extension length 302 of the reinforcement bracket 300 to span a range of distances to match the extension length 256 of the first or second rails 220, 224.

Referring to FIG. 4, in some examples, the reinforcement extension length 302 is not adjusted to match the extension length 256. For example, the reinforcement extension length 302 may be adjusted to be about 50% of the extension length 256. In other examples, the reinforcement extension length 302 may be adjusted to be about 40%, about 60%, about 70%, about 80%, about, 90%, or about 95% of the extension length 256. In some examples, a maximum length of the reinforcement extension length 302 may be less than a maximum length of the extension length 256. For example, the maximum length of the reinforcement extension length 302 may be about 40%, about 50%, about 60%, about 70%, about 80%, about, 90%, or about 95% of the maximum length of the extension length 256. In such examples, the reinforcement bracket 300 that defines the reinforcement extension length 302 that is less than the extension length 256 of the support bracket 200 may be more easily installed onto the rails 220, 224 or, if preinstalled, allow easier installation of the bracket 200 onto building structure (e.g., with appropriate positioning along an overlap between the rails 244a, 248b or the rails 244b, 248a to stabilize the support assembly 200, while reducing the amount of material needed to manufacture the reinforcement bracket 300).

In order to provide proper support to the support bracket 200, one or more of the reinforcement brackets 300 may be nested into the first and second bracket members 204, 208 along one or more of the first and second rails 220, 224. In some examples, as shown in FIG. 7A-7B, the rails 220, 224 may each include a cross-sectional profile 258 taken transverse to an extension direction of the support bracket 200. The cross-sectional profiles 258 of the rails 220, 224 may define interior volumes 259 extending along the length of the support bracket 200. For example, the rails 220, 224 may define the cross-sectional profiles 258 that are C-shaped. Furthermore, one or more of the interior volumes 259 may receive and retain at least a portion of the reinforcement bracket 300 through a rear (or other) opening 260 of the cross-sectional profile 258.

In some examples, a shape of the reinforcement bracket 300 may conform to the rear opening 260 in one or both of the first and second rails 220, 224. As illustrated in FIG. 7A, for example, a front protrusion 303 of the reinforcement bracket 300 can be nested into the rear opening 260 of the first rail 220. Consequently, the front protrusion 303 of the reinforcement bracket 300 extending into the support bracket 200 may position the reinforcement bracket 300 partially within the interior volume 259 of the first rail 220 and partially outside of the interior volume 259 of the first rail 220. The nesting of the reinforcement bracket 300 within the opening 260 of the first rail 220 may help to further decrease flex or other adverse deformation or movement of the support bracket 200, by providing more points of contact between the reinforcement bracket 300 and the first rail 220 and a more interconnected and compact overall configuration.

When nested in the rear opening 260 (or otherwise secured), the reinforcement bracket 300 may extend asymmetrically from a first centerline 264 of the corresponding rail 220, 224 (e.g., a reference line centered or substantially centered on the rails 220, 224 relative to a height of the rail measured transverse to the extension direction (e.g., vertically centered for stud-mounted applications)). Similarly, in some examples, the reinforcement bracket 300 may extend asymmetrically from a second centerline 265 of the corresponding rail 220, 224 that extends transverse to the first centerline 264 and along the extension direction (as shown in FIG. 4).

For example, as shown in FIG. 7A, relative to a direction that is transverse to the centerlines 264, 265 of the rail 220 and the telescoping direction of the bracket 300, a first portion 316 of the reinforcement bracket 300, may extend away from the equipment 104 (e.g., vertically upward, as shown), farther from the centerlines 264, 265 than does a second portion 320 of the reinforcement bracket 300 that extends toward the equipment 104 (e.g., vertically downward, as shown). In some embodiments, an edge of the first portion 316 that is farthest from the centerlines 264, 265, may be aligned with a top edge of the first rail 220. Conversely, the second portion 320 may not extend as far from the centerlines 264, 265 as a bottom edge of the first rail 220.

In some examples, the first portion 316 and the second portion 320 of the reinforcement bracket 300 may extend from the protrusion 303. As such, the reinforcement bracket 300 may extend asymmetrically in opposing directions from the protrusion 303, along the opposing directions that are oriented transverse to the extension direction of the support bracket 200 and the reinforcement bracket 300.

In the illustrated example, the offset between the second portion 320 and the bottom edge of the first rail 220 may form a ledge 268. The ledge 268 may be configured to engage a spring arm 120 of the equipment 104 (e.g., a hooked arm, as shown), to provide the equipment 104 a more secure coupling to the support bracket 200.

Referring to FIG. 7B, the reinforcement bracket 300 may be nested similarly with the second rail 224 (e.g., for installation with a second instance of the bracket 300 also installed on the first rail 220, as discussed above). For example, the edge of the first portion 316 of the reinforcement bracket 300 may be aligned with a bottom edge of the second rail 224. The second portion 320 may be offset from a top edge of the second rail 220 to form the ledge 268 that is configured to engage a spring arm 120 of the equipment 104 (e.g., a hooked arm, as shown).

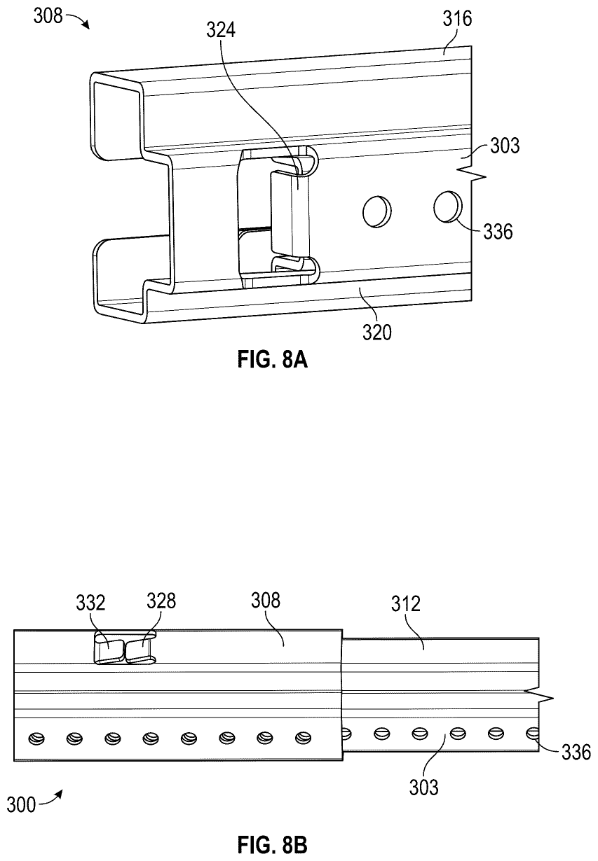

Referring to FIG. 8A, the first reinforcement member 308 and the second reinforcement member 312 may include one or more stop tabs configured to prevent over insertion or over extension of the reinforcement bracket 300. The first stop tab 324 may extend from the first reinforcement member 308, into an inner profile of the first reinforcement member 308. The first stop tab 324 may prevent over-insertion of the second reinforcement member 312 into the first reinforcement member 308. In some examples, the first stop tab 324 may be disposed adjacent a first end of the first reinforcement member 312.

Referring to FIG. 8B, a second stop tab 328 may also extend from the first reinforcement member 308, into an inner profile of the first reinforcement member 308. The second stop tab 328 may be configured to contact an outer surface of the second reinforcement member 312, to reduce unwanted telescopic adjustment of the reinforcement bracket 300 and help reduce lateral wobble. In some examples, the second stop tab 328 may be disposed adjacent a second end of the first reinforcement member 312, opposite the first end.

In some examples, a third stop tab 332 may extend from the second reinforcement member 312, away from an inner profile of the second reinforcement member 312. The third stop tab 332 may be configured to contact an inner surface of the first reinforcement member 308, to reduce unwanted telescopic adjustment of the reinforcement bracket 300. During extension of the reinforcement bracket 300 (e.g., at a first extension length of the reinforcement bracket 300), the second stop tab 328 and the third stop tab 332 may be configured to engage one another, to prevent over-extension of the support bracket 300 (e.g., past the first extension length, with a corresponding, inadvertent separation of the members 308, 312).

In different examples, a reinforcement bracket can be anchored to a support bracket in various ways. As noted above, for example, the fasteners 118 (e.g., screws or other threaded fasteners) can be used in some cases. In this regard, the reinforcement members 308, 312 can include a plurality of reinforcement bracket mounting holes 336, configured to receive the fasteners 118 for securing the reinforcement bracket to the support bracket 200. For example, of the reinforcement members 308, 312 may include a corresponding set of the reinforcement bracket mounting holes 336, spaced apart along the corresponding reinforcement members 308, 312. In some examples, plurality of reinforcement bracket mounting holes 336 can be equidistantly spaced along the respective reinforcement members 308, 312. For example, adjacent reinforcement bracket mounting holes 336 may be spaced apart by the first spacing along the first reinforcement member 308. Furthermore, adjacent reinforcement bracket mounting holes 336 may be spaced apart by the first spacing on the second reinforcement bracket 312. With the plurality of reinforcement bracket mounting holes 336 and the plurality of support bracket mounting holes 257 defining a similar or identical spacing (e.g., the first spacing, as noted above), the holes 257, 336 may be easier to align for cooperatively receiving the fasteners 118 as described further below.

In some examples, the support bracket mounting holes 257 of the support bracket 200 and the reinforcement bracket mounting holes 336 of the reinforcement bracket 300, may be selectively alignable by adjustment of an extension of the support bracket 200 and the reinforcement bracket 300 to cooperatively receive the fasteners 118 (e.g., screws shown in FIG. 1). Specifically, the support bracket mounting holes 257 of one of the rails 220, 224 and the reinforcement bracket mounting holes 336 of the reinforcement bracket 300 may be selectively alignable by adjustment of the extension of the support bracket 200 and the reinforcement bracket 300 to cooperatively receive the fasteners 118 (e.g., screws shown in FIG. 1).

In this regard, the reinforcement bracket 300 may be secured to one of the rails 220, 224 of the support bracket 200. Furthermore, in some examples, a different instance of the reinforcement brackets 300 may be secured to each of the rails 220, 224 of the support bracket 200. Accordingly, for example, a user can easily utilize the fasteners 118 to anchor one or more of the reinforcement brackets 300 to the telescoping members 204, 208 (e.g., with four fasteners at four corners of the overall assembly, as shown in FIG. 1). Specifically, the fasteners 118 securing the reinforcement bracket 300 to the support bracket 200 may extend through one or more of the rails 244a, 244b, 248a, 248b, and one or more of the reinforcement members 308, 312 (as shown in FIGS. 1 and 7A).

In some examples, the fasteners 118 may secure the equipment 104 to both the support bracket 200 and the reinforcement bracket 300. Specifically, the fasteners 118 securing the equipment 104 to the support bracket 200 may extend through one or more of the rails 244a, 244b, 248a, 248b, and one or more of the reinforcement members 308, 312 based on the position of the equipment 104 relative to the support bracket 200 (as shown in FIGS. 1 and 7A).

Thus, examples of the disclosed technology can provide improved systems for telescopically supporting electrical equipment between building structures including assemblies with electrical boxes or electrical devices of various kinds, including light fixtures (e.g., luminaires), fans, low voltage devices (e.g., outlets, switches, and other low voltage devices), and any other electrical device that can be mounted on a building structure. Some examples provide a support assembly that is inexpensive to manufacture while providing an improved mechanism for mitigating bending, flexing, or failure of the support bracket after installation.

Also as used herein, the use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “substantially centered” indicates that a center of a feature or component relative to a reference direction is within 10% of center of another feature or component relative to the reference direction. For example, for a body having a length L relative to a first direction, a feature that is substantially centered on the body along a first direction has a center that is located at a distance of within 0.1*L of a midpoint of the body along the first direction. In contrast, unless otherwise limited or defined, “offset” indicates that a center of a feature or component is not substantially centered on another component.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

I/We claim:

1. A bracket assembly to support electrical devices relative to building structures, the bracket assembly comprising:
a support bracket configured to support an electrical device between a first building structure and a second building structure,
the support bracket including a first bracket member securable to the first building structure and a second bracket member securable to the second building structure, the first bracket member being slidably nested with the second bracket member to:
define an upper rail, and a lower rail spaced apart from the upper rail to define a bracket opening that receives the electrical device; and
provide telescopic adjustment of a length of the support bracket between the first and second building structures, via telescopic adjustment of the upper and lower rails; and
a reinforcement bracket secured to the first bracket member and the second bracket member along one of the upper rail or the lower rail, the reinforcement bracket including a first reinforcement member slidably nested with a second reinforcement member to provide telescopic adjustment of a length of the reinforcement bracket along the one of the upper rail or the lower rail.

2. The bracket assembly of claim 1, wherein the reinforcement bracket is secured along a rear side of the support bracket.

3. The bracket assembly of claim 2, wherein the support bracket is configured to secure the electrical device at a front side of the support bracket, opposite the rear side, to provide access to the electrical device via the bracket opening.

4. The bracket assembly of claim 1, wherein the reinforcement bracket is nested into the first and second bracket members along the one of the upper rail or the lower rail.

5. The bracket assembly of claim 4, wherein the one of the upper rail or the lower rail defines a first cross-sectional profile having a first internal volume; and
wherein the reinforcement bracket is positioned partially within the first internal volume and partially outside of the first internal volume.

6. The bracket assembly of claim 5, wherein the one of the upper rail or the lower rail defines an opening into the first internal volume, extending along the length of the support bracket; and
wherein the reinforcement bracket includes a protrusion that extends into the first internal volume through the opening.

7. The bracket assembly of claim 1, wherein, transverse to a telescoping direction of the reinforcement bracket, the reinforcement bracket extends asymmetrically in opposing directions from one or more of:
a protrusion of the reinforcement bracket that is nested into the first and second bracket members along the one of the upper rail or the lower rail; or
a centerline of the one of the upper rail or the lower rail that extends along a telescoping direction of the support bracket.

8. The bracket assembly of claim 1, wherein the first bracket member includes a plurality of first bracket member holes, wherein the first reinforcement member includes a plurality of first reinforcement member holes, and wherein the plurality of first bracket member holes and the plurality of first reinforcement member holes are selectively alignable at a plurality of configurations by telescopic movement of the support bracket and the reinforcement bracket, to cooperatively receive fasteners to secure the first reinforcement member to the first bracket member.

9. The bracket assembly of claim 1, wherein the first reinforcement member includes a first stop tab, the first stop tab extending to contact the second reinforcement member, wherein the second reinforcement member includes a second stop tab, the second stop tab extending to contact the first reinforcement member;
and wherein at a first extension length of the reinforcement bracket, the first stop tab contacts the second stop tab to block further extension of the reinforcement bracket.

10. The bracket assembly of claim 1, wherein a maximum telescopic length of the reinforcement bracket is at least 50% of a maximum telescopic length of the support bracket.

11. The bracket assembly of claim 1, wherein the reinforcement bracket is secured to the upper rail, and a second reinforcement member is secured to the lower rail.

12. A bracket assembly to support electrical devices relative to building structures, the bracket assembly comprising:
a support bracket including a first bracket member slidably nested with a second bracket member to adjustably provide a range of extension lengths of the support bracket to support an electrical device between a first building structure and a second building structure; and
a reinforcement bracket secured to the first bracket member and the second bracket member, the reinforcement bracket including a first reinforcement member telescopically movable relative to a second reinforcement member to provide a range of reinforcement lengths of the reinforcement bracket.

13. The bracket assembly of claim 12, wherein the reinforcement bracket further comprises a front protrusion nested into a rear opening of the support bracket.

14. The bracket assembly of claim 13, wherein, transverse to a telescoping direction of the reinforcement bracket, the reinforcement bracket extends asymmetrically in opposing directions from the front protrusion.

15. The bracket assembly of claim 12, wherein the reinforcement bracket is secured to a first side of the support bracket, and wherein the support bracket is configured to secure the electrical device at a second side of the support bracket, opposite the first side.

16. A method of assembling a bracket assembly comprising:
slidably adjusting a first bracket member of a telescoping support bracket nested within a second bracket member relative to the second bracket member;
slidably adjusting a first reinforcement member of a telescoping reinforcement bracket nested within a second reinforcement bracket member relative to the second reinforcement bracket member; and
securing the telescoping reinforcement bracket to the first bracket member and the second bracket member.

17. The method of claim 16, further comprising nesting the telescoping reinforcement bracket within the telescoping support bracket.

18. The method of claim 17, wherein nesting the telescoping reinforcement bracket within the telescoping support bracket includes positioning a protrusion of the telescoping reinforcement bracket to extend through an opening in the telescoping support bracket.

19. The method of claim 16, further comprising securing an electrical device to a front side of the telescoping support bracket; and
wherein securing the telescoping reinforcement bracket to the telescoping support bracket includes fastening the telescoping reinforcement bracket to a rear side of the telescoping support bracket, opposite the front side.

20. The method of claim 16, wherein adjusting the reinforcement bracket includes aligning a plurality of reinforcement member holes disposed along the reinforcement bracket with a plurality of bracket member holes disposed along the support bracket, and further includes inserting a fastener through the aligned reinforcement member holes to secure the reinforcement bracket to the support bracket.
